(19) United States
(12) Patent Application Publication
(10) Pub. No.: US 2026/0092642 A1
(43) Pub. Date: Apr. 2, 2026

(54) MOTOR SHAFT FOR AN ELECTRIC MOTOR, ELECTRIC MOTOR, AND DRIVE DEVICE FOR AN ELECTRIC BICYCLE

(71) Applicant: Porsche eBike Performance GmbH, Ottobrunn (DE)

(72) Inventors: Jörg Aniol, Leonberg (DE); Harald Hobohm, Maulbronn (DE); Andreas Hoppe, Munich (DE)

(21) Appl. No.: 19/337,679

(22) Filed: Sep. 23, 2025

(30) Foreign Application Priority Data
Sep. 30, 2024 (DE) 10 2024 128 278.9

(51) Int. Cl. F16H 57/00; B62M 6/55; F16H 1/28; F16H 55/17; F16H 57/08

(52) U.S. Cl. CPC F16H 57/0018; B62M 6/55; F16H 1/28; F16H 55/17; F16H 57/08; F16H 2057/085

(57) ABSTRACT

A motor shaft is for an electric motor of an electric bicycle. The motor shaft has a toothing for transmitting motor torque. The toothing is produced via a forming process. An electric motor includes a motor shaft. A drive device of an electric bicycle includes the electric motor having the motor shaft.

### CROSS-REFERENCE TO RELATED APPLICATIONS

This application claims priority of German patent application no. 10 2024 128 278.9, filed Sep. 30, 2024, the entire content of which is incorporated herein by reference.

### TECHNICAL FIELD

The disclosure relates to a motor shaft for an electric motor of an electric bicycle. In addition, the disclosure relates to an electric motor and a drive device for an electric bicycle.

### BACKGROUND

Bicycles have long been popular as an easy-to-use and emission-free means of transportation. Over many years, in addition to city bikes, sports and fitness equipment have also become widely used, and special types of bicycles have emerged for different areas of application.

For years, enthusiasm for electric bicycles (especially so-called “pedelecs”) has been growing steadily, despite their comparatively high weight and price compared to conventional bicycles. Potential riders are not only older people who are less fit or have no sporting ambitions, but also athletic, younger riders, whether for use on their way to work or because of the possibility of extending their range and/or increasing their riding speed without overstraining their own physique. Interest in electrically assisted bicycles seems to be growing particularly strongly among mountain bikers and road cyclists.

With electric bicycles, it has always been a concern to provide a reliable, supportive drive device.

### SUMMARY

It is an object of the disclosure to specify a concept for a drive device for an electric bicycle that enables particularly efficient production.

According to a first aspect, a motor shaft for an electric motor of an electric bicycle is disclosed. The motor shaft has a toothing for transmitting motor torque. In particular, the toothing serves to transmit torque from the electric motor to a gearbox or directly to an output shaft for driving the electric bicycle. The toothing is manufactured via a forming process.

The inventors have recognized that manufacturing the toothing (also called output toothing) of the motor shaft via a forming process, and thus not via machining, offers particular advantages, especially for electric bicycles.

This means that the toothing, which is preferably a running toothing, can be manufactured particularly efficiently, especially in comparison to machining, which is significantly more complex. However, the toothing can also be a plug toothing.

Furthermore, the forming process enables a particularly compact configuration for the motor shaft, because unlike machining of the toothing, the disclosure does not require any tool runout or freewheel for a cutting tool. This means that less installation space is required axially on the motor shaft, that is, along the axis of rotation of the motor shaft. In other words, a particularly large amount of installation space can be saved due to the special manufacturing of the toothing, which is a great advantage, especially in the case of electric drives, which are already compact. For example, this results in more space for other components such as a radial shaft seal.

Further advantages are that the toothing has a particularly smooth surface and particularly good hardness due to the manufacturing process using a forming method. In other words, the surface quality is many times better than with machining. This eliminates subsequent processes such as fine grinding of the toothing or a hardening process. This enables savings in manufacturing time and costs.

Another advantage is that the toothing according to the disclosure does not place high demands on the tolerances and quality of the gear partners (that is, the gear with which the toothing engages). Due to the high surface quality, the toothing can interact with a toothing partner such as one or more planet gears of a planetary gearbox, which is made entirely of plastic or whose counter toothing is made of plastic. The high surface quality (especially smoothness) effectively counteracts wear such as abrasion. The toothing according to the disclosure thus enables a durable and low-wear solution.

The motor shaft described can also serve as a sun gear for a planetary gearbox.

According to an embodiment, the forming process is a rolling process. In other words, it is a rolled toothing or the toothing is manufactured by rolling. This contributes in particular to the above-mentioned advantages and functions.

According to an embodiment, the toothing is an integral part of the motor shaft. In other words, the toothing is formed in one piece with the motor shaft. This contributes to a particularly efficient manufacture of the motor shaft. In particular, it is not necessary to connect the toothing to the motor shaft as a separate component.

According to an embodiment, the toothing is configured as helical toothing. Preferably, it is involute helical toothing. The teeth can run at an angle to the axis of rotation of the motor shaft or in a helical or spiral shape around this axis of rotation. Helical gearing enables higher power transmission compared to straight gearing and is quieter during operation.

According to an embodiment, the motor shaft is made of a steel material, in particular case-hardened steel or stainless steel. This contributes to the above-mentioned functions and advantages. In particular, the choice of a steel material enables high rigidity and strength for the motor shaft and thus, especially in a one-piece configuration, for the toothing. This is advantageous in a particularly compact drive device for an electric bicycle.

According to an embodiment, a magnet is provided at an axial end of the motor shaft facing away from the toothing, which is pressed axially into the motor shaft via a separate adapter. The magnet is necessary for a motor position sensor. In particular, if the motor shaft is made of a magnetic or magnetizable material such as steel, this can have undesirable effects on the magnetic field of the magnet. The adapter counteracts this by acting as a decoupling element between the separate magnet and the motor shaft.

According to an embodiment, the adapter is made of aluminum. This is particularly effective in preventing the motor shaft from interfering with the magnet or its magnetic field.

According to an embodiment, the motor shaft has a shaft stub at an axial end facing the toothing. The shaft stub can be configured to support the motor shaft and/or as a connection point for measuring purposes, in particular as a torque measurement point, for example via a clamping coupling, in order to be able to test the electric motor separately or for an end-of-line test. The shaft stub, also known as the shaft extension, is an axial section of the motor shaft that extends axially from the toothing and forms an end section of the motor shaft. This can be used both for installation in a drive device of the electric bicycle for supporting the motor shaft and for testing purposes of the motor shaft, that is, before installation in the drive device, for example, if the motor shaft must be rotatably supported for testing purposes. Without the stub, mounting would not be possible or would have to be in the area of the toothing, which would cause damage to the toothing.

At this point, it should be mentioned that the axial end facing away refers to the end of the motor shaft that faces away from a pedal crank axle or pedal axle when the motor shaft is installed in its normal operating position. Conversely, the facing end refers to the end that faces the pedal crank axle in the normal installation state of the motor shaft.

According to a second aspect, an electric motor for an electric bicycle is disclosed. The electric motor has a motor shaft according to the first aspect.

The electric motor enables the above-mentioned functions and advantages. The embodiments described above for the motor shaft apply analogously.

According to a third aspect, a drive device for an electric bicycle is disclosed. The drive device has an electric motor according to the second aspect. The drive device has a planetary gearbox with a planet carrier and at least one planet gear. The drive device has an output drive. The planetary gear is rotatably mounted on the planet carrier.

The toothing of the motor shaft is in engagement with the planetary gear. The electric motor is coupled to the output drive via the planetary gearbox to transmit torque from the electric motor to the output drive.

The disclosed drive device enables the above-mentioned functions and advantages. The embodiments described above for the motor shaft and the electric motor apply analogously.

In the drive device, the electric motor is coupled to the output via the planetary gearbox to transmit torque from the electric motor to the output. In other words, the planetary gearbox is connected between the electric motor and the output. The planetary gearbox is specifically configured to increase the torque delivered by the electric motor. For example, the planetary gearbox is arranged axially between the electric motor and the output. The electric motor includes a stator and a rotor. For example, the electric motor is an internal rotor motor.

The output is the component of the drive device from which torque is transmitted from the drive device. For example, the output includes an output shaft. The output shaft may be a hollow shaft. For example, a pedal axle of the drive device extends through the output shaft. The output shaft may be connected in a rotationally fixed manner to a chainring or a chainring spider. Alternatively or additionally, the output shaft has an interface for a coupling with a chainring or a chainring spider.

In the drive device, the planet carrier is mounted so that it can rotate about a rotational axis. This means, in particular, that the planet carrier can rotate relative to a housing of the drive device. Unless otherwise specified, directions parallel to the rotational axis of the planet carrier are referred to here and in the following as “axial directions” or simply as “axial. ” Furthermore, unless otherwise indicated, the directional terms “radial” and “azimuthal” refer to this axis of rotation. For example, the planet carrier is formed to be rotationally symmetrical with respect to its axis of rotation.

The planet gear is mounted in a bearing so that it can rotate relative to the planet carrier. The axis of rotation of the planet gear runs parallel or essentially parallel to the axis of rotation of the planet carrier. During operation, the axis of rotation of the planet gear rotates around the axis of rotation of the planet carrier.

For the rotary mounting of the planet gear on the planet carrier, the planet gear may have a bolt or pin that is inserted through or into a recess in the planet carrier. Alternatively, the planet carrier may have a bolt or bushing that is inserted through a hole in the planet gear.

The planetary gearbox may have two or more, for example three, planet gears. The planet gears are then all rotatably mounted on the planet carrier. In particular, each of the planet gears is rotatably mounted on the planet carrier via a bearing. All features disclosed in connection with one planet gear are also disclosed below for all further planet gears of the planetary gearbox.

In addition to the planet carrier and the at least one planet gear, the planetary gearbox also includes a ring gear and a sun gear. The planet gear meshes with the sun gear and the ring gear. The ring gear can be connected to the housing in a rotationally fixed manner, that is, it does not rotate during operation. The sun gear rotates, for example, about the same axis of rotation as the planet carrier. The planet carrier may be made of metal. The planet gear may be made partly of plastic.

According to at least an embodiment, the motor shaft forms the sun gear of the planetary gearbox. This means that the sun gear is an integral part of the motor shaft. In other words, the motor shaft and sun gear are formed in one piece. This is particularly advantageous with regard to the planet gears that engage with the sun gear and whose toothing is made of plastic, because, as described above, the forming process makes the surface of the sun gear's teeth particularly smooth, allowing the planet gears to roll particularly well. Planetary gears with plastic toothing offer the advantage that they tolerate greater tolerances in the toothing of the sun gear than, for example, planetary gears with metal toothing.

According to an embodiment, the planet gear is mounted on the planet carrier in a rotatable manner via a needle bearing.

According to an embodiment, the planet gear has a metal sleeve. The metal sleeve forms a running surface for the rolling elements of the needle bearing. The needle bearing can be a needle cage.

According to an embodiment, the sleeve is formed with a plastic material. In particular, the sleeve is overmolded with the plastic material. The planet gear may consist of the metal sleeve and the plastic material.

The needle bearing includes elongated, in particular needle-shaped or pin-shaped rolling elements. The rolling elements may be cylindrical or conical. The lengths of the rolling elements, measured along their longitudinal axes, are each greater than their maximum diameter. For example, the length is at least twice as large or at least four times as large or at least ten times as large as the diameter. The longitudinal axes of the rolling elements run in particular parallel or essentially parallel to the axis of rotation of the planet gear and/or the planet carrier. The rolling elements may include or consist of metal, for example steel. For example, the lengths of the rolling elements of the needle bearing are each at least 50% or at least 75% of the thickness of the planet gear, wherein the thickness of the planet gear is its extension in the axial direction.

A bushing or pin of the planet carrier can be inserted through the metal sleeve. This bushing or pin forms a further running surface for the rolling elements of the needle bearing. This means that the rolling elements of the needle bearing are arranged between the metal sleeve of the planet gear and the bushing/pin of the planet carrier.

The present disclosure is also based on the realization that when planetary gearboxes are used in a drive device for an electric bicycle, forces can act that can lead to relative tilting between the planet gear and the planet carrier. Such tilting increases wear on the drive device, but also leads to unwanted noise and power losses. “Tilting” here and in the following refers in particular to a relative rotation about an axis perpendicular to the axis of rotation of the planet carrier.

The drive device described here contributes to lower wear, lower noise generation, and higher performance by mounting the at least one planet gear on the planet carrier in a particularly stable manner against tilting. This stable mounting is achieved in particular by a needle bearing. In fact, a needle bearing has a relatively long support extension in the axial direction, which allows relative tilting to be well supported. The needle bearing also has low radial play, which also counteracts tilting.

According to an embodiment, the planet gear has a counter-tooth for engagement with the toothing of the motor shaft. The counter-tooth is made of plastic material. The at least one planet gear is either partially made of plastic or completely made of plastic. As described above, the toothing produced in the forming process allows for a combination of metal and plastic materials. A planet gear made of plastic or at least the counter teeth made of plastic enable a particularly lightweight configuration of the drive device, which has an impact on the overall weight of the electric bicycle.

According to at least an embodiment, the at least one planet gear has helical teeth. We refer to the above explanations regarding the motor shaft. The sun gear and the ring gear then have respective helical teeth that engage with the helical teeth of the planetary gear.

Due to the helical teeth, tilting moments act on the planet gear during operation, which could cause the planet gear to tilt relative to the planet carrier. This is counteracted in particular by the needle bearing.

According to an embodiment, the drive device has a bevel gear stage between the planetary gearbox and the output. In particular, the bevel gear stage couples the planetary gearbox to the output. In other words, the bevel gear stage is connected between the planetary gearbox and the output. The bevel gear stage is configured, for example, to further increase the torque delivered by the planetary gearbox. The bevel gear stage may be a 90° bevel gear stage. The planetary gearbox is arranged, for example, axially between the electric motor and the bevel gear stage.

Coupling the planetary gearbox with the bevel gear stage allows a high tilting moment to act on the planetary carrier during operation of the drive device. This also carries the risk of relative tilting between the planet gear and the planetary carrier, which can be effectively compensated for with the aid of the needle bearing.

According to an embodiment, the bevel gear stage is coupled to the planetary gearbox without an intermediate gear stage. In other words, the respective torque delivered by the planetary gearbox corresponds to the torque fed into the bevel gear stage. For example, a component of the planetary gearbox is rotationally coupled to a bevel gear of the bevel gear stage.

According to an embodiment, the planet carrier is rotationally coupled to a first bevel gear of the bevel gear stage. This means that, during operation, the first bevel gear rotates together with the planet carrier around the axis of rotation of the planet carrier at the same rotational speed and in the same direction. In particular, the first bevel gear is connected directly to the planet carrier, for example via a form-fit and/or force-fit connection. Alternatively, the planet carrier and the first bevel gear could also be formed integrally with each other. The first bevel gear is, for example, a bevel pinion.

According to an embodiment, the bevel gear stage includes a second bevel gear. The second bevel gear meshes with the first bevel gear. For example, the second bevel gear is coupled to the output without an intermediate gear stage. A rotational axis of the second bevel gear runs obliquely or perpendicularly to the rotational axis of the planet carrier or the first bevel gear. The axis of rotation of the output is, for example, parallel or identical to the axis of rotation of the second bevel gear. The second bevel gear is, for example, a ring gear. The drive device is, for example, an orthogonal drive.

According to an embodiment, the second bevel gear is coupled to the output via a freewheel. For example, the freewheel couples the second bevel gear with the output shaft of the output.

According to an embodiment, the planet carrier is mounted in the drive device so that it can rotate with the aid of a radial bearing. Preferably, the planet carrier is additionally mounted in the drive device so that it can rotate with the aid of an axial bearing. The radial bearing and the axial bearing are, in particular, roller bearings. For example, only the one radial bearing and only the one axial bearing are used for the rotary mounting of the planet carrier. For example, no further radial bearing and/or axial bearing is used for the rotary mounting of the first bevel gear.

The axial bearing supports the planet carrier in the axial direction and can absorb forces acting in the axial direction. This is particularly advantageous when an axial force and/or a tilting moment acts on the planet carrier, for example due to the coupling to the bevel gear stage.

According to an embodiment, the radial bearing is coupled both directly to the planet carrier and directly to the housing of the drive device. In particular, the radial bearing adjoins the housing and the planet carrier in the radial direction. For example, an outer ring of the radial bearing adjoins the housing in the radial direction and an inner ring of the radial bearing adjoins the planet carrier in the radial direction. In the area where the radial bearing adjoins the housing in the radial direction, the housing is formed with a single wall, for example, and forms an outer surface of the drive device opposite the radial bearing.

According to an embodiment, the radial bearing is at least partially at the same height as the planet gear in the radial direction. For example, the radial bearing protrudes radially away from the axis of rotation of the planet carrier beyond the planet gear. In particular, the radial bearing is further away from the axis of rotation of the planet carrier in the radial direction than the axis of rotation of the planet gear. Alternatively or additionally, the radial bearing may be located at least in sections at the same height as the ring gear of the planetary gearbox in the radial direction.

According to an embodiment, the radial bearing is arranged axially between the axial bearing and the second bevel gear of the bevel gear stage. In particular, the radial bearing is arranged at least in sections at the height of the planet carrier in the axial direction.

According to an embodiment, the thrust bearing has elongated rolling elements. The rolling elements may be cylindrical or conical. The thrust bearing may be a needle bearing.

According to an embodiment, the thrust bearing is arranged in the radial direction on the outer circumference of the planet carrier. This means that the thrust bearing is arranged as far away as possible from the axis of rotation of the planet carrier on the planet carrier. This results in a particularly large span of the thrust bearing. For example, the support width of the axial bearing is greater than the axial distance between the radial bearing and the interface between the two bevel gears of the bevel gear stage. The interface of the bevel gears is understood here to be the area in which the toothing of the two bevel gears mesh with each other.

According to an embodiment, the thrust bearing and the planet gear of the planetary gearbox are at least partially at the same height in the radial direction. In other words, there is an area of the thrust bearing that is just as far away from the axis of rotation of the planet carrier in the radial direction as an area of at least one planet gear. In particular, the thrust bearing is spaced further apart in the radial direction from the axis of rotation of the planet carrier than the axis of rotation of the planet gear. Alternatively or additionally, the thrust bearing and the ring gear of the planetary gearbox are located at the same height in the radial direction, at least in sections.

According to an embodiment, the motor shaft protrudes into the first bevel gear. For example, the motor shaft extends through the planet carrier, in particular completely through it, and into the first bevel gear. The first bevel gear has a recess for this purpose with an opening facing the electric motor, through which the motor shaft is guided into the recess. The motor shaft can rotate within the recess relative to the first bevel gear.

According to an embodiment, the output shaft of the output is coupled to a pedal shaft of the drive device via a freewheel. The freewheel is, for example, a toothed disc freewheel. The pedal shaft is in particular guided through the output shaft, wherein the output shaft is formed as a hollow shaft.

According to an embodiment, the pedal shaft extends perpendicular to the axis of rotation of the planet carrier. In other words, an axis of rotation of the pedal shaft is perpendicular to the axis of rotation of the planet carrier.

### BRIEF DESCRIPTION OF DRAWINGS

The invention will now be described with reference to the drawings wherein:

FIG. 1 shows an embodiment of the electric bicycle;

FIG. 2 shows a motor shaft according to an embodiment of the disclosure; and,

FIG. 3 shows a drive device according to an embodiment of the disclosure.

### DETAILED DESCRIPTION

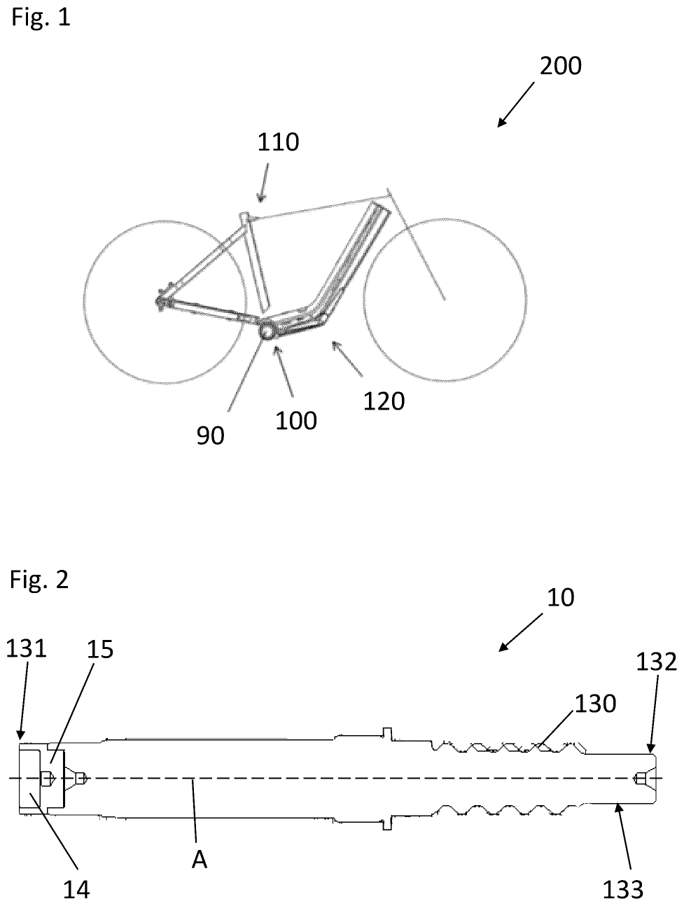

FIG. 1 schematically shows an electric bicycle 200 with a bicycle frame 110, which has a lower frame section 120. This forms a down tube. The lower frame section 120 extends in the direction of a bottom bracket of the electric bicycle, wherein the bottom bracket includes a pedal shaft 90. The pedal shaft 90 is part of a drive device 100 installed in the bicycle.

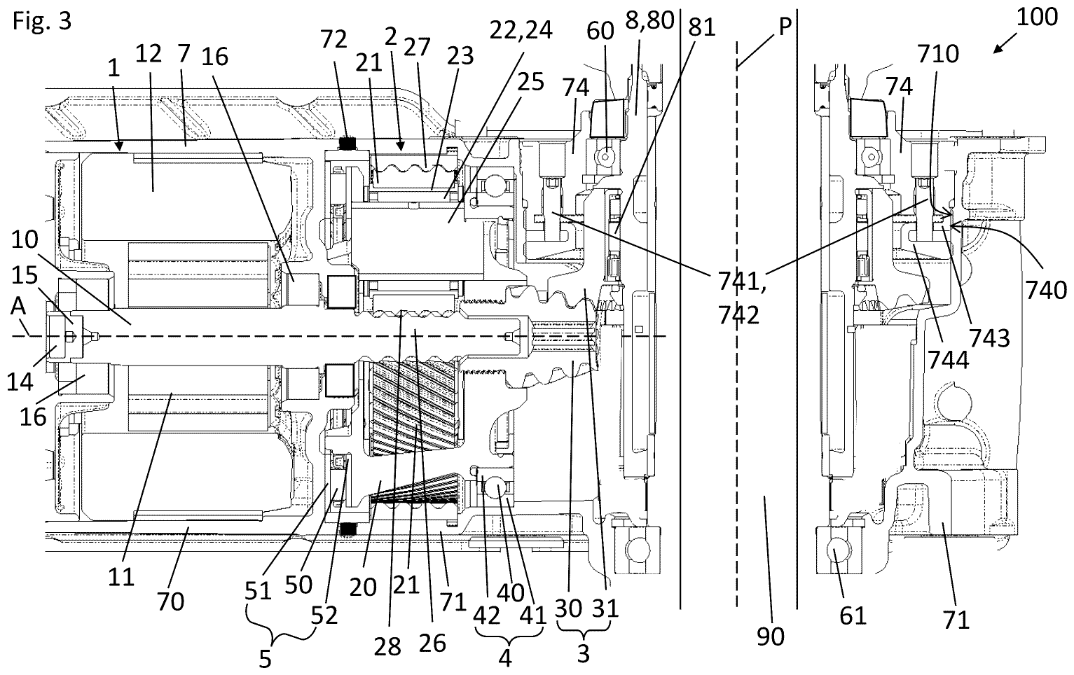

FIG. 2 schematically shows a motor shaft 10 according to an embodiment of the disclosure. This is a motor shaft for an electric motor of an electric bicycle, such as a pedelec. The electric motor is, for example, part of a drive device of the electric bicycle. The motor shaft 10 is driven by the electric motor and is configured to deliver torque to drive the electric bicycle. Torque is delivered either directly or indirectly, for example via one or more gear stages, to an output of the electric bicycle. In particular, the motor shaft 10 is suitable for coupling with a planetary gearbox, as will be described in more detail in FIG. 3.

The motor shaft 10 has a toothing 130 on the output side for delivering the torque generated by the electric motor. The toothing 130 is a running toothing, which is configured as a helical toothing. This means that the teeth do not run parallel, but at an angle or helically around the axis of rotation A of the motor shaft. In view of the advantages and functions mentioned at the beginning, the toothing 130 is produced via a forming process, namely the rolling process. This means that the toothing for the sun gear 26 is not manufactured by cutting, which can be recognized, for example, by the absence of milling marks and, in particular, by the absence of tool run-out. The toothing 130 is formed in one piece with the motor shaft 10 and is therefore an integral part of the motor shaft 10.

The motor shaft 10 is made of case-hardened steel and therefore has high strength and bending stiffness.

The motor shaft 10 has an axial end 131 (the left end in FIG. 2) facing away from the toothing 130 in the axial direction along the axis of rotation A and an axial end 132 facing the toothing 130. The two ends 131 and 132 are opposite each other. In other words, the facing axial end 132 is located on the output side of the motor shaft 10, while the facing axial end 131 is located on the side of the electric motor facing away from the output.

The motor shaft 10 has a magnet 14 at the opposite axial end 131 (the left end in FIG. 2), which is firmly connected to the motor shaft 10. The magnet 14 is used for a motor position sensor of the drive device (not shown), which detects a magnetic field of the magnet 14 and thereby allows the position of the motor shaft 10 to be determined qualitatively and quantitatively. However, since the motor shaft 10 itself is made of steel and is therefore a magnetic material, the motor shaft 10 would influence the magnetic field of the magnet 14 and thus impair the measurement. In order to at least reduce these interfering influences, an adapter 15 is arranged between the magnet 14 and the motor shaft 10. The adapter 15 is inserted into the motor shaft 10 and the magnet 14 is in turn inserted into the adapter 15. In particular, the two components are each pressed in. The adapter 15 is made of aluminum. For this reason, and due to the fact that the magnet 14 is spaced axially from the motor shaft 10 by the adapter 15, the influence of the steel motor shaft 10 on the magnetic field generated by the magnet 14 is at least reduced or even essentially completely avoided.

At the facing axial end 132, the motor shaft 10 has a shaft stub 133. The shaft stub 133 is a cylindrical section of the motor shaft 10 that connects to the toothing 130 in the axial direction. The shaft stub 133 enables the advantages and functions mentioned at the beginning, such as particularly good bearing of the motor shaft 10.

An embodiment of a drive device 100 with the motor shaft 10 described above is described with reference to FIG. 3.

FIG. 3 shows a further embodiment of the drive device 100 in a cross-sectional view. The drive device 100 includes a housing 7 with three interconnected housing parts 70, 71, 74. The housing part 70 forms a motor housing in which an electric motor 1 is accommodated. Housing part 71 forms a bottom bracket housing in which, among other things, a planetary gearbox 2 is accommodated. The motor housing 70 and the bottom bracket housing 71 are connected to each other via a sealing sleeve 72. Housing part 74 forms an output-side cover that is screwed onto the bottom bracket housing 71.

Electric motor 1 includes a stator 12 and a rotor 11. Electric motor 1 is an internal rotor motor. During operation, the rotor 11 rotates relative to the stator 12 or the housing 7 about a rotational axis A. The rotor 11 is coupled to the motor shaft 10 as described above in FIG. 2 and also causes it to rotate about the rotational axis A during operation. The rotational axis A runs through the motor shaft 10. The electric motor 1 is mounted in the housing 7 via motor bearings 16.

The motor shaft 10 protrudes in an axial direction from the rotor 11 and into the planet carrier 20 of the planetary gearbox 2. In the opposite axial direction, the motor shaft 10 has the magnet 14, which is arranged as described above and is spaced from the motor shaft 10 by the adapter 15.

The planetary gearbox 2, which forms a first gear stage of the drive device 100, includes the planet carrier 20, three planet gears 21, a sun gear 26, and a ring gear 27. FIG. 3 shows a first planet gear 21, namely the one above the axis of rotation A, in cross-sectional view, whereas another planet gear 21 is shown in top view. The planet gears 21 are mounted on the planet carrier 20 so that they can rotate. Similarly, the planet carrier 20 is mounted so that it can rotate about the axis of rotation A via two roller bearings 4, 5. In the present case, the planet carrier 20 has bushings 25 which are inserted through holes in the planet gears 21.

The sun gear 26 for the planetary gearbox 2 is an integral part of the motor shaft 10, that is, the motor shaft 10 and the sun gear 26 are formed in one piece or as a single unit.

The toothing 130 of the sun gear 26 or the motor shaft 10 engages with respective counter toothing 28, that is, helical toothing, of the planet gear 21. Rotation of the motor shaft 10 causes the planet gears 21 to rotate, which in turn causes the planet carrier 20 to rotate about the axis of rotation A. The planet gears 21 roll off the stationary ring gear 27. The ring gear 27 is fixed to the housing 7, for example, and therefore does not rotate relative to the housing 7 during operation.

The use of a forming process in the manufacture of the teeth of the sun gear 26 results in a particularly smooth tooth surface. The teeth of the planet gears 21 are made of plastic, for example. The smooth surface of the sun gear 26 is particularly advantageous when plastic is used for the planet gears 21, as this minimizes wear. Planet gears made entirely or partially of plastic are more tolerant of manufacturing tolerances and are less sensitive to tilting relative to the planet carrier 20.

In fact, a tilting moment acts on the planet gears 21, which tends to tilt the planet gears 21 relative to the planet carrier 20. This tilting moment results largely from the use of helical teeth. However, the helical teeth are advantageous in terms of high power transmission and low noise generation.

In order to minimize tilting of the planet gears 21 relative to the planet carrier 20 and to counteract it as effectively as possible, the planet gears 21 are each mounted on the planet carrier 20 in a rotatable manner via a needle bearing 22. The needle-shaped or cylindrical rolling elements 24 of the needle bearing 22 roll on the bushings 25 on one side and on the sleeves 23 on the other side. The bushings 25 and the sleeves 23 are made of metal, for example. The sleeves 23 are part of the planet gear 21 and are encased or overmolded with plastic, whereby the toothing of the planet gear 21 is formed from this plastic. By reducing the relative tilt between the planet gears 21 and the planet carrier 20 due to the use of the needle bearings 22, the wear of the drive device 100 can be reduced and its performance increased.

The planet carrier 20 has a recess at an axial end facing away from the motor 1. The axis of rotation A runs through this recess. In the area of the recess, the planet carrier 20 has an internal thread. A first bevel gear 30, namely a bevel pinion, of a bevel gear stage 3 is screwed into this internal thread. The bevel gear stage 3 forms a second gear stage of the drive device 100. The first bevel gear 30 has a cylindrical section with an external thread and a conical section with external teeth. The cylindrical section is screwed into the recess of the planet carrier 23, whereby the first bevel gear 30 is fastened to the planet carrier 23 and is immovable relative to the planet carrier 20, that is, it is connected to the latter in a rotationally fixed manner. The first bevel gear 30 is precisely aligned relative to the planet carrier 20 with the aid of a centering collar. The conical section protrudes axially from the planet carrier 20 away from the electric motor 1.

The first bevel gear 30 has a recess that is open in the direction of the electric motor 1 and into which the motor shaft 10 is guided. The motor shaft 10 can rotate freely within this recess. Unlike in FIG. 3, the motor shaft 10 could be rotatably mounted within the recess via a bearing.

The section of the motor shaft 10 protruding into the recess of the bevel gear 30 is free of toothing. This section forms, for example, an interface for a so-called “stand-alone” test of the electric motor 1, that is, a test in an uninstalled state.

During operation, the planet carrier 20 and the first bevel gear 30 rotate together around the axis of rotation A. The bevel gear stage 3 has a second bevel gear 31 in the form of a ring gear. The second bevel gear 31 is mounted so that it can rotate around a pedal axis P, with the pedal axis P running perpendicular to the axis of rotation A. The bevel gear stage 3 is therefore a 90° bevel gear stage.

The second bevel gear 31 is coupled to an output shaft 80 in the form of a hollow shaft via a freewheel 81. The output shaft 80 is part of an output 8. The output 8 also includes, for example, a chainring and/or a chainring spider (not shown), which are connected to the output shaft 80 in a rotationally fixed manner. Alternatively, the output shaft 80 may also only have an interface for a rotationally fixed coupling with the chainring or the chainring spider.

A pedal shaft 90 extends through the hollow shaft-shaped output shaft 80. The pedal shaft 90 is coupled to the output shaft 80. The pedal shaft 90 and the output shaft 80 are rotatably mounted via radial bearings 60, 61, the so-called main bearings 60, 61. When the rider of the electric bicycle pedals, the pedal shaft 90 rotates around the pedal axle P, thereby driving the output shaft 80 via a freewheel. The electric motor 1 exerts a torque on the output shaft 80 via the planetary gearbox 2 and the bevel gear stage 3 to assist the rider. The drive device 100 shown is an orthogonal drive.

By using a bevel gear stage 3 coupled directly to the planet carrier 20, that is, without any further intermediate gear stages, the drive device 100 can be configured to be particularly compact and at the same time provides efficient speed reduction from the electric motor 1 to the output 8. However, the direct coupling between the planet carrier 20 and the bevel gear stage 3 also results in the bevel gear stage 3 exerting an axial force, a radial force, and an azimuthal force on the planet carrier 20 during operation of the drive device 100. These forces attempt to push the planet carrier 20 toward electric motor 1 and simultaneously tilt the planet carrier 20.

In order to efficiently absorb the acting radial forces, the planet carrier 20 is mounted in the housing 7 via a large radial bearing 4. The radial bearing 4 has, for example, an inner diameter of 5 cm. The radial bearing 4 is supported by the planet carrier 20.

The axial forces that occur are absorbed by a thrust bearing 5. In particular, the tilting moment that acts on the planet carrier 20 results in a large axial load on the thrust bearing 5. The thrust bearing 5 also has a large diameter. Here, the axial bearing 5 is arranged at the outer edge or outer circumference of the planet carrier 20, that is, radially as far as possible from the axis of rotation A. In addition, elongated rolling elements, for example cylinders or cones, are used as rolling elements 50 of the axial bearing 5, whereby the load is distributed over a larger area.

In order to minimize tilting of the planet carrier 20, the axial play for the planet carrier 20 between the radial bearing 4 and the axial bearing 5 is kept particularly small, for example, a maximum of 0.1 mm. Among other things, this is achieved by a small tolerance chain in the axial direction. The small tolerance chain is implemented as follows: A thrust washer 51 of the axial bearing 5, on which the rolling elements 52 roll, is arranged in the axial direction directly opposite a support element, namely a radially extending part of the motor housing 70. The other thrust washer 52 of the axial bearing 5 is arranged in the axial direction directly opposite the planet carrier 20. Furthermore, the inner ring 42 of the radial bearing 4, on which the rolling elements 40 of the radial bearing 4 roll, is arranged in the axial direction directly opposite the planet carrier 20, and the outer ring 41 of the radial bearing 4 is arranged in the axial direction directly opposite a further support element, namely a part of the bottom bracket housing 71. The motor housing 70 and the bottom bracket housing 71 are connected to each other in an axially immovable manner. The elements directly opposite each other in the axial direction either abut each other or are spaced apart from each other by narrow gaps in the axial direction at most. In particular, the sum of the axial distances between the aforementioned directly opposite elements is less than 0.1 mm.

When the drive device 100 is installed and the motor is running, the planet carrier 20 is pressed axially toward the electric motor 1. The planet carrier 20 then rests axially directly on the thrust washer 52, and the thrust washer 51 rests axially directly on the motor housing 70. The small axial distances mentioned above ensure that the planet carrier 20 hardly tilts at all despite the strong tilting moment.

Another measure to reduce the tilting of the planet carrier 20 is a small radial clearance for the planet carrier 20 and the first bevel gear 30. For this purpose, the first bevel gear 30 is firmly connected to the planet carrier 20. The play of the planet carrier 20 in the radial direction is kept low by the fact that the radial bearing 4 used for the radial mounting of the planet carrier 20, which is arranged radially between the planet carrier 20 and the housing 7, abuts the planet carrier 20 with its inner ring 42 and the housing 7 with its outer ring 41 in the radial direction. No intermediate elements are used between the radial bearing 4 and the housing 7, as these could increase the play of the planet carrier 20 or the first bevel gear 30 in the radial direction. In other words, by using fewer elements in the radial tolerance chain, the radial play of the first bevel gear 30 and the planet carrier 20 is kept low. This means that the planet carrier 20 can only tilt to a limited extent.

Overall, the use of the radial bearing 4 and the axial bearing 5 described above helps to counteract tilting of the planet carrier 20 and to absorb the forces acting on it efficiently. This makes the drive device 100 particularly powerful while at the same time ensuring low wear.

Performance is further enhanced by the precise alignment of the bevel gears 30, 31 with each other. This is achieved on the one hand by the low-backlash bearing arrangement of the planet carrier 20 and the first bevel gear 30 described above, and on the other hand by a low-backlash bearing arrangement of the second bevel gear 31. For this purpose, the second bevel gear 31 is connected to the output shaft 80 in a fixed, that is, immovable, manner. The output shaft 80, in turn, is mounted via the radial bearing 60 so that it can rotate about the axis of rotation P, with the radial bearing 60 being in direct contact with the output shaft 80 on the one hand and in direct contact with the cover 74 on the other. The cover 74, in turn, is firmly connected to the bottom bracket housing 71. Here too, in order to reduce the play of the second bevel gear 31 in the axial direction, parallel to the axis of rotation A, a rotatable bearing of the second bevel gear 31 around the axis of rotation P is realized with few movable elements between the housing 7 and the second bevel gear 31.

The fixed connection between the housing parts 71, 74 is a screw connection. For this screw connection, the bottom bracket housing 71 and the cover 74 have threads 710, 740 that interlock.

These threads 710, 740 extend around the axis of rotation P of the pedal shaft 90. The relative arrangement between the housing parts 71 and 74 is secured via clamping elements 742. The clamping elements 742 are screws in this case, which are screwed into receptacles 741 of the housing part 74. Specifically, the housing part 74 has two ring-shaped sections 743, 744, which are formed in the cross-sectional view shown by a U-shaped area of the third housing part 74, that is, they are spaced apart from each other by a gap in the direction parallel to the axis of rotation P. The two sections 743, 744 each form part of the external thread 740 of the housing part 74. The screwed-in screws 742 press the second section 744 away from the first section 743 with a longitudinal end, causing the screw connection between the housing parts 71, 74 to jam and thus fixing them in their relative arrangement to each other.

The second bevel gear 31 is restricted in its movement relative to the third housing element 74 in a direction parallel to the axis of rotation P via stop surfaces. The screw connection between the housing parts 71, 74 therefore allows the second bevel gear 31 to be positioned particularly accurately along the axis of rotation P. The fixing of the screw connection then ensures a particularly stable position of the second bevel gear 31 in the direction of the axis of rotation P. Overall, the bevel gears 30, 31 are then aligned with each other with particular precision, which benefits the performance of the entire drive device 100.

It is understood that the foregoing description is that of the preferred embodiments of the invention and that various changes and modifications may be made thereto without departing from the spirit and scope of the invention as defined in the appended claims.

### LIST OF REFERENCE SYMBOLS

1 Electric motor
2 Planetary gearbox
3 Bevel gear stage
4 Radial bearing
5 Axial bearing
7 Housing
8 Output
10 Motor shaft
11 Rotor
12 Stator
14 Magnet
15 Adapter for magnet
16 Motor bearing
20 planet carrier
21 planet gear
22 Needle bearing
23 Outer sleeve
24 Rolling element
25 Bushing/bolt
26 sun gear
27 ring gear
28 Counter gear
30 First gear/bevel pinion
31 Second gear/ring gear
40 Rolling element
41 Outer ring
42 Inner ring
50 Rolling element
51 Thrust washer
52 Thrust washer
60 Radial bearing
61 Radial bearing
70 Motor housing
71 Bottom bracket housing
72 Sealing sleeve
74 Cover
80 Output shaft
81 Freewheel
90 Pedal shaft
100 Drive device
110 Bicycle frame
120 Down tube
130 Toothing
131 Away axial end
132 Tow axial end
133 Shaft stub
200 Electric bicycle
710 Thread
740 Thread
741 Receptacle
742 Fixing element/screw
743 First section
744 Second section
A Rotation axis
Pedal shaft/rotation axis

1. A motor shaft for an electric motor of an electric bicycle, the motor shaft comprising:
a toothing for transmitting motor torque; and, said toothing being produced via a forming process.

2. The motor shaft of claim 1, wherein said forming process is a rolling process.

3. The motor shaft of claim 1, wherein said toothing is an integral part of the motor shaft.

4. The motor shaft of claim 1, wherein said toothing is a helical toothing.

5. The motor shaft of claim 1, wherein the motor shaft is made of a steel material.

6. The motor shaft of claim 1, wherein the motor shaft is made of a case-hardened steel or stainless steel.

7. The motor shaft of claim 1 further comprising a magnet at an axial end facing away from said toothing; and, said magnet being pressed axially into the motor shaft via a separate adapter.

8. The motor shaft of claim 6, wherein said adapter is formed from an aluminum material.

9. The motor shaft of claim 1, wherein the motor shaft has a shaft stub at an axial end facing said toothing; and, said shaft stub is at least one of configured to support the motor shaft and a connection point for measuring purposes.

10. An electric motor for an electric bicycle, comprising the motor shaft of claim 1.

11. A drive device for an electric bicycle, the drive device comprising:
an electric motor including a motor shaft having a toothing for transmitting motor torque;
said toothing being produced via a forming process;
a planetary gearbox having a planet carrier and at least one planet gear;
an output;
said at least one planet gear being rotatably mounted on said planet carrier;
said toothing of said motor shaft being in engagement with said planet gear; and,
said electric motor being coupled to said output via said planetary gearbox in order to transmit torque from said electric motor to said output.

12. The drive device of claim 11, wherein said motor shaft forms a sun gear of said planetary gearbox.

13. The drive device of claim 11, wherein:
said planet gear is rotatably mounted on said planet carrier via a needle bearing;
said planet gear has a metal sleeve; and,
said sleeve is formed with plastic material.

14. The drive device of claim 11, wherein said planet gear has a counter-tooth for engagement with said toothing of said motor shaft; and, said counter-tooth is formed from a plastic material.
